(19) United States
(12) Patent Application Publication
(10) Pub. No.: US 2023/0071612 A1
(43) Pub. Date: Mar. 9, 2023

(54) VEHICLE TRAVEL PATH GENERATION DEVICE AND METHOD FOR GENERATING A VEHICLE TRAVEL PATH

(71) Applicant: Mitsubishi Electric Corporation, Tokyo (JP)

(72) Inventors: Yu TAKEUCHI, Tokyo (JP); Toshihide SATAKE, Tokyo (JP); Kazushi MAEDA, Tokyo (JP); Shuuhei NAKATSUJI, Tokyo (JP)

(73) Assignee: Mitsubishi Electric Corporation, Tokyo (JP)

(21) Appl. No.: 17/794,772

(22) PCT Filed: Feb. 14, 2020
(86) PCT No.: PCT/JP2020/005793

§ 371 Date: Jul. 22, 2022

(51) Int. Cl. B60W 30/12; B60W 40/072; B60W 40/076

(52) U.S. Cl. CPC B60W 30/12; B60W 40/072; B60W 40/076; B60W 2420/42

(57) ABSTRACT

In order to generate an improved travel path with sufficient accuracy, a vehicle travel path generation device includes a first travel path generation part (60) which approximates a lane on which a host vehicle (1) travels to output first travel path information, a second travel path generation part (70) which approximates a road division line ahead of the host vehicle (1) to output second travel path information, a travel path weight setting part (90) which sets a weight between the first travel path information and the second travel path information, and an integrated path generation part (100) which generates an integrated path information using the first travel path information, the second travel path information, and the weight by the travel path weight setting part (90), wherein the travel path weight setting part (90) sets the weight, on the basis of at least one of outputs from a bird's-eye view detection travel path weight setting part (91), a vehicle state weight setting part (92), a path distance weight setting part (93) and a peripheral environment weight setting part (94).

### FIELD OF THE INVENTION

The present application relates to the field of a vehicle travel path generation device and the field of a method for generating a vehicle travel path.

### BACKGROUND OF THE INVENTION

In a drive support device, that detects the division line of a road with a front recognition camera which is mounted in a vehicle, computes an autonomous sensor target travel path from the shape of a white line of a detected host vehicle drive lane, and holds a travel by employing the autonomous sensor target travel path as a travel path, there remains a subject that the detection performance of a road division line deteriorates due to the traffic jam and the deterioration of weather, and then, the drive support cannot be continued.

Toward this subject, there is a proposal in which at least two trajectories are detected, from among a trajectory of a target path on which a host vehicle travels, a running trajectory of a leading car which travels ahead of a host vehicle, and a running trajectory of a parallel running car which travels parallel to a host vehicle or a leading vehicle, where those trajectories are detected using the information from a front recognition camera which is mounted in a host vehicle. Further, the trajectories are unified with their own weight, and the unified integrated path is defined as a target path (Patent Document 1).

Moreover, a drive control device is proposed which detects lane information using a variable adoption ratio between graphical image information and map information, and sets a target travel path, where the variable adoption ratio depends on the reliability of the graphical image information with a front recognition camera, and the reliability of the high precision map information by the GNSS, such as the GPS, which includes a lane central point group, white line position information, and the like, of the peripheral road of a host vehicle. (Patent Document 2).

### CITATION LIST

### Patent Literature

Patent Document 1 Japanese Unexamined Patent Application Publication No. 2018-39285
Patent Document 2 Japanese Unexamined Patent Application Publication No. 2017- 47798

### SUMMARY OF THE INVENTION

### Technical Problem

In the conventional device for generating a travel path, the graphical image information is obtained with a camera which recognizes the front, and the travel path of a vehicle is generated. However, it is desired that the accuracy of control is further enhanced.

The present application aims at offering a vehicle travel path generation device which presumes and outputs the travel path of a vehicle, so that an optimal control may be conducted according to a state in which the host vehicle is placed.

### Solution to Problem

A vehicle travel path generation device according to the present application, includes

a first travel path generation part which approximates a lane on which a host vehicle travels to output as first travel path information,

a second travel path generation part which approximates a road division line ahead of the host vehicle to output as second travel path information,

a travel path weight setting part which sets a weight denoting a certainty between the first travel path information and the second travel path information, and

an integrated path generation part which generates an integrated path information, using the first travel path information, the second travel path information, and the weight by the travel path weight setting part,

wherein the travel path weight setting part sets the weight, on the basis of at least one of outputs from a bird's-eye view detection travel path weight setting part, a vehicle state weight setting part, a path distance weight setting part, and a peripheral environment weight setting part,

where the bird's-eye view detection travel path weight setting part computes a weight between the first travel path information and the second travel path information, on the basis of the first travel path information,

the vehicle state weight setting part computes a weight between the first travel path information and the second travel path information, on the basis of a state of the host vehicle,

the path distance weight setting part computes a weight between the first travel path information and the second travel path information, on the basis of a distance of a travel path of the second travel path information, and

the peripheral environment weight setting part computes a weight between the first travel path information and the second travel path information, on the basis of a peripheral road environment of the host vehicle.

### Advantageous Effects of Invention

The vehicle travel path generation device according to the present application makes it possible to generate a travel path with sufficient accuracy, according to the state where the host vehicle is placed.

### BRIEF EXPLANATION OF DRAWINGS

FIG. 1 is a block diagram showing the constitution of a travel path generation device according to an Embodiment 1.

FIG. 2 is a block diagram showing the details of a path weight setting part of the travel path generation device according to the Embodiment 1.

FIG. 3 is a flow chart which shows the details in the generation of a travel path according to the Embodiment 1.

FIG. 4 is a flow chart which shows the details in the setting of a path weight for the generation of a travel path according to the Embodiment 1.

FIG. 5 is a flow chart which shows the details in the setting of a bird's-eye view detection travel path weight for the generation of a travel path according to the Embodiment 1.

FIG. 6 is a drawing for explaining the operation, in the case where the weight for a second travel path is set to be smaller than the weight for a first travel path, in a bird's-eye view detection travel path weight setting part according to the Embodiment 1.

FIG. 7 is a drawing showing a first image capturing state of a front camera sensor, in the case where the weight for the second travel path is set to be smaller than the weight for the first travel path, in the bird's-eye view detection travel path weight setting part according to the Embodiment 1.

FIG. 8 is a drawing showing a second image capturing state of the front camera sensor, in the case where the weight for the second travel path is set to be smaller than the weight for the first travel path, in the bird's-eye view detection travel path weight setting part according to the Embodiment 1.

FIG. 9 is a drawing showing a third image capturing state of the front camera sensor 30, in the case where the weight for the second travel path is set to be smaller than the weight for the first travel path, in the bird's-eye view detection travel path weight setting part according to the Embodiment 1.

FIG. 10 is a drawing showing a first image capturing state of the front camera sensor, in the case where the weight for the first travel path and the weight for the second travel path are set to be equal, in the bird's-eye view detection travel path weight setting part according to the Embodiment 1.

FIG. 11 is a flow chart which shows the details in the setting of a vehicle state weight for the generation of a travel path according to the Embodiment 1.

FIG. 12 is a drawing showing a first image capturing state of the front camera sensor, in the case where the weight for the first travel path and the weight for the second travel path are set to be equal, in a vehicle state weight setting part according to the Embodiment 1.

FIG. 13 is a drawing showing an image capturing state of the front camera sensor, in the case where the weight for the second travel path is set to be smaller than the weight for the first travel path, in the vehicle state weight setting part according to the Embodiment 1.

FIG. 14 is a flow chart which shows the details in the setting of a path distance weight for a method for generating a travel path according to the Embodiment 1.

FIG. 15 is a drawing for explaining the operation in the case where the weight for the second travel path is set to be smaller than the weight for the first travel path, in a path distance weight setting part according to the Embodiment 1.

FIG. 16 is a flow chart which shows the details in the setting of a peripheral environment weight for the method of generating a travel path according to the Embodiment 1.

FIG. 17 is a drawing showing an image capturing state of the front camera sensor, in the case where the weight for the second travel path is set to be smaller than the weight for the first travel path, in a peripheral environment weight setting part according to the Embodiment 1.

FIG. 18 is a block diagram showing the constitution of a travel path generation device and a vehicle control device, according to the Embodiment 1.

FIG. 19 is a drawing showing the operation of an integrated travel path generation part, in the case where each of the paths is denoted by a point group, in the travel path generation device according to the Embodiment 1.

FIG. 20 is a block diagram showing an example of the hardware of the travel path generation device according to the Embodiment 1.

### DESCRIPTION OF EMBODIMENTS

### Embodiment 1

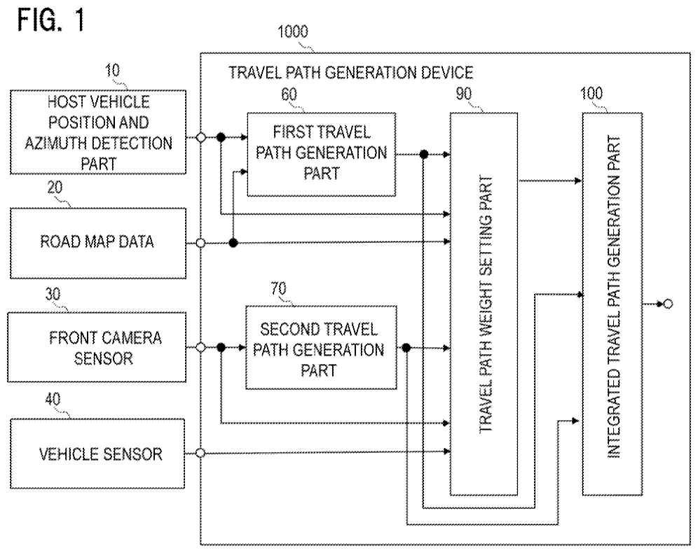

FIG. 1 is a block diagram showing the constitution of a travel path generation device 1000 according to the Embodiment 1.

As shown in FIG. 1, the travel path generation device 1000 receives information on the coordinate position and azimuth of a host vehicle, from a host vehicle position and azimuth detection part 10; information, from a road map data 20, which includes the information on the central target point sequence of the peripheral drive lane of a host vehicle; information on the detection results of a division line and detection reliability, from a front camera sensor 30; information on a division line ahead of a host vehicle, from a front camera sensor 30; and information which is detected with vehicle sensors 40, containing a speed sensor, a yaw rate sensor, and a front and behind acceleration sensor. Further, the travel path generation device outputs information about a travel path in response to the received information. The host vehicle position and azimuth detection part 10 is the one which detects the coordinate position and azimuth of a host vehicle, using the information for positioning from an artificial satellite, and outputs detection results and the reliability of a positioning state.

From the host vehicle position and azimuth detection part 10 and the road map data 20, a first travel path generation part 60 approximates, by a polynomial equation, a lane on which a host vehicle should travel, and outputs the approximation result as the first travel path information. A second travel path generation part 70 approximates, by a polynomial equation, a front road division line which is acquired with the front camera sensor 30, and outputs the approximation result as the second travel path information.

For example, the first travel path information which the first travel path generation part 60 outputs and the second travel path information, which the second travel path generation part 70 outputs, are equivalent of determining each of the coefficients for a lateral position deviation, an angle deviation, a path curvature, and a path curvature deviation, with respect to a host vehicle and an approximated curve. It is worth noticing that, henceforth, the first travel path information and the second travel path information are abbreviated as the first travel path and the second travel path, respectively.

From the information of the first travel path generation part 60, the host vehicle position and azimuth detection part 10, the road map data 20, the second travel path generation part 70, the front camera sensor 30, and the vehicle sensor 40, the travel path weight setting part 90 sets a weight, which denotes the certainty between the first travel path of the first travel path generation part 60 and the second travel path of the second travel path generation part 70, that is, the ratio of possibility. The integrated travel path generation part 100 outputs an integrated travel path which is the one integrated to a single path, on the basis of the information of the first travel path generation part 60, the second travel path generation part 70, and the travel path weight setting part 90.

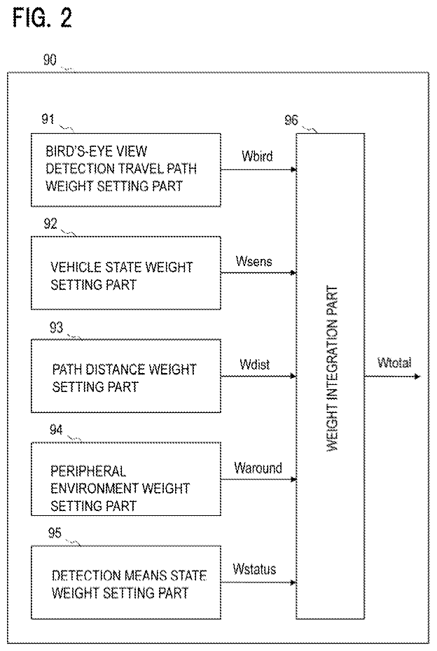

Next, on the basis of FIG. 2, explanation will be made about the detailed constitution of the path weight setting part 90 of FIG. 1. As shown in FIG. 2, the path weight setting part 90 is equipped with a bird's-eye view detection travel path weight setting part 91, a vehicle state weight setting part 92, a path distance weight setting part 93, a peripheral environment weight setting part 94, and a detection means state weight setting part 95. On the basis of the information from the first travel path generation part 60, the bird's-eye view detection travel path weight setting part 91 sets a weight between the first travel path and the second travel path, that is, a bird's-eye view detection travel path weight W bird.

On the basis of the information from the vehicle sensor 40, the vehicle state weight setting part 92 sets a weight between the first travel path and the second travel path, that is, a vehicle state weight W sens. On the basis of the information on the path distance for both travel paths of the first travel path generation part 60 and the second travel path generation part 70, the path distance weight setting part 93 sets a weight between the first travel path and the second travel path, that is, a path distance weight W dist. On the basis of the information from the road map data 20, the peripheral environment weight setting part 94 sets a weight between the first travel path and the second travel path, that is, a peripheral environment weight W map.

On the basis of the information on the reliability of both travel paths of the first travel path generation part 60 and the second travel path generation part 70, the detection means state weight setting part 95 sets a weight between the first travel path and the second travel path, that is, a detection means state weight W status. The weight integration part 96 computes a final weight W total between the first travel path and the second travel path, from the bird's-eye view detection travel path weight W bird according to the bird's-eye view detection travel weight setting part 91, the Vehicle state weight W sens according to the vehicle state weight setting part 92, the path distance weight W dist according to the path distance weight setting part 93, the peripheral environment weight W map according to the peripheral environment weight setting part 94, and the detection means state weight W status according to the detection means state weight setting part 95. After that, the weight integration part 96 outputs the result of computation to the integrated travel path generation part 100.

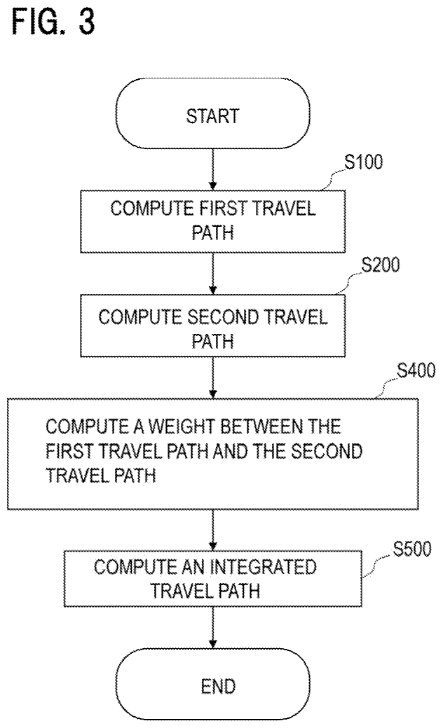

Next, using the flow chart of FIG. 3, explanation will be made about the overall operation of the path generation device according to the Embodiment 1. It is worth noticing that, the flow chart of FIG. 3 is the one which is repeatedly conducted while a vehicle is moving.

First, in the first travel path generation part 60, a target point sequence (a point sequence arranged fundamentally in the lane center) of a lane on which a host vehicle is traveling presently and the state of the host vehicle are computed as an approximate expression on a host vehicle reference coordinate system, from the information of the host vehicle position and azimuth detection part 10 and the road map data 20. The expression is represented as the Equation 1 (Step S100).

### [Equation 1]

Eq. 1

path_1_{(x)=C}3_1×x^{3+C}2_1×x²+C1_1×x+C0_1 (Equation 1)

Next, in the second travel path generation part 70, the travel path on which a host vehicle should travel is computed from the information of a division line which is detected with the front camera sensor 30, where the division line is ahead of a host vehicle. The expression is represented as the Equation 2 (Step S200).

### [Equation 2]

Eq. 2

path_2₍ₓ₎=C3_2×x³C2_2×x²+C1_2×x+C0_2 (Equation 2)

In the Equation 1 and the Equation 2, the first term denotes the curvature of each path, the second term denotes an angle of a host vehicle with respect to each path, the third term denotes a lateral position of a host vehicle with respect to each path. Next, a travel path for each of the states is computed in Step S100 and Step S200. In addition, a weight W for each travel path, which is represented by the Equation 3, is computed by the path weight setting part 90 (Step S400).

$$[ Equation 3 ]$$

$$Eq . 3$$

$$W = ( \begin{matrix}{W}_{total \_ 1} \\ {W}_{total \_ 2}\end{matrix} ) = ( \begin{matrix}{W}_{total \_ 1 \_ C 3} & {W}_{total \_ 1 \_ C 2} & {W}_{total \_ 1 \_ C 1} & {W}_{total \_ 1 \_ C 0} \\ {W}_{total \_ 2 \_ C 3} & {W}_{total \_ 2 \_ C 2} & {W}_{total \_ 2 \_ C 1} & {W}_{total \_ 2 \_ C 0}\end{matrix} ) \qquad ( Equation 3 )$$

After that, in the integrated travel path generation part 100, an integrated travel path Path_total, on which a host vehicle should travel, is computed by the Equation 4, from the paths computed in Step S100 and Step S200 and the weights to the respective paths computed in Step S400 (Step S500).

It is worth noticing that, as for the computing operation of each of the paths in Step S100 and Step S200, computed results at one side do not influence the computing operation of the other side. Therefore, there are no restrictions about an order of computation.

$$\{ Equation 4 ]$$

$$Eq . 4$$

$${path\_total}_{( x )} = path\_ {1}_{( x )} \times \frac{{W}_{total \_ 1}}{{W}_{total \_ 1} + {W}_{total \_ 2}} + path\_ {2}_{( x )} \times \frac{{W}_{total \_ 2}}{{W}_{total \_ 1} + {W}_{total \_ 2}} \qquad ( Equation 4 )$$

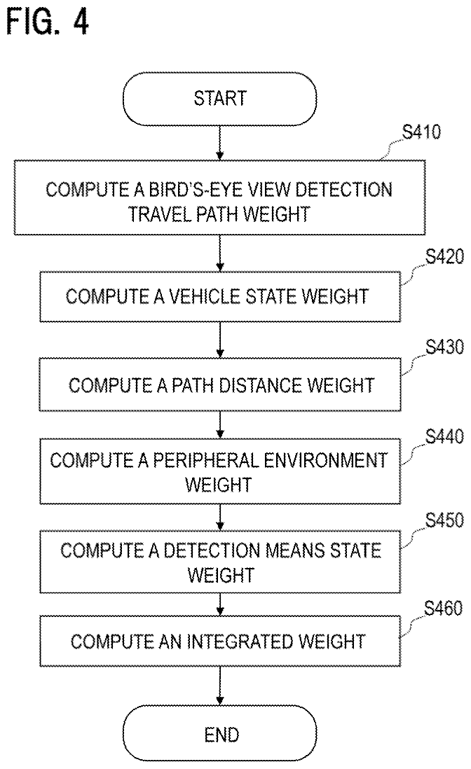

Next, using the flow chart of FIG. 4, explanation will be made about the operation of the path weight setting part 90 which sets a weight to each of the travel paths of the first travel path and the second travel path. It is worth noticing that, FIG. 4 shows the details of the operation in Step S400 of FIG. 3, and computation for every step in the flow chart is performed, while the vehicle is moving.

First, using the information from the first travel path generation part 60, a bird's-eye view detection travel path weight W bird is set, and is represented as the Equation 5 (Step S410).

$$[ Equation 5 ]$$

$$Eq . 5$$

$${W}_{\_ bird} = ( \begin{matrix}{W}_{\_ bird \_ 1} \\ {W}_{\_ bird \_ 2}\end{matrix} ) = ( \begin{matrix}{W}_{\_ bird \_ 1 \_ c 3} & {W}_{\_ bird \_ 1 \_ c 2} & {W}_{\_ bird \_ 1 \_ c 1} & {W}_{\_ bird \_ 1 \_ c 0} \\ {W}_{\_ bird \_ 2 \_ c 3} & {W}_{\_ bird \_ 2 \_ c 2} & {W}_{\_ bird \_ 2 \_ c 1} & {W}_{\_ bird \_ 2 \_ c 0}\end{matrix} ) \qquad ( Equation 5 )$$

Next, using the information from the vehicle sensor 40, a vehicle state weight W sens is set, and is represented as the Equation 6 (Step S420).

$$[ Equation 6 ]$$

$$Eq . 6$$

$${W}_{\_ sens} = ( \begin{matrix}{W}_{\_ sens \_ 1} \\ {W}_{\_ sens \_ 2}\end{matrix} ) = ( \begin{matrix}{W}_{\_ sens \_ 1 \_ c 3} & {W}_{\_ sens \_ 1 \_ c 2} & {W}_{\_ sens \_ 1 \_ c 1} & {W}_{\_ sens \_ 1 \_ c 0} \\ {W}_{\_ sens \_ 2 \_ c 3} & {W}_{\_ sens \_ 2 \_ c 2} & {W}_{\_ sens \_ 2 \_ c 1} & {W}_{\_ sens \_ 2 \_ c 0}\end{matrix} ) \qquad ( Equation 6 )$$

Next, using the information on the path distance of each of the paths of the first travel path generation part 60 and the second travel path generation part 70, a path distance weight W dist is set, and is represented as the Equation 7 (Step S430).

$$[ Equation 7 ]$$

$$Eq . 7$$

$${W}_{\_ dist} = ( \begin{matrix}{W}_{\_ dist \_ 1} \\ {W}_{\_ dist \_ 2}\end{matrix} ) = ( \begin{matrix}{W}_{\_ dist \_ 1 \_ c 3} & {W}_{\_ dist \_ 1 \_ c 2} & {W}_{\_ dist \_ 1 \_ c 1} & {W}_{\_ dist \_ 1 \_ c 0} \\ {W}_{\_ dist \_ 2 \_ c 3} & {W}_{\_ dist \_ 2 \_ c 2} & {W}_{\_ dist \_ 2 \_ c 1} & {W}_{\_ dist \_ 2 \_ c 0}\end{matrix} ) \qquad ( Equation 7 )$$

Next, using the information from the road map data 20, a peripheral environment weight W map is set, and is represented as the Equation 8 (Step S440).

$$[ Equation 8 ]$$

$$Eq . 8$$

$${W}_{\_ map} = ( \begin{matrix}{W}_{\_ map \_ 1} \\ {W}_{\_ map \_ 2}\end{matrix} ) = ( \begin{matrix}{W}_{\_ map \_ 1 \_ c 3} & {W}_{\_ map \_ 1 \_ c 2} & {W}_{\_ map \_ 1 \_ c 1} & {W}_{\_ map \_ 1 \_ c 0} \\ {W}_{\_ map \_ 2 \_ c 3} & {W}_{\_ map \_ 2 \_ c 2} & {W}_{\_ map \_ 2 \_ c 1} & {W}_{\_ map \_ 2 \_ c 0}\end{matrix} ) \qquad ( Equation 8 )$$

Next, using the information on the reliability of each of the paths of the first travel path generation part 60 and the second travel path generation part 70, a detection means state weight W stasus is set, and is represented as the Equation 9 (Step S450).

$$[ Equation 9 ]$$

$$Eq . 9$$

$${W}_{\_ status} = ( \begin{matrix}{W}_{\_ status \_ 1} \\ {W}_{\_ status \_ 2}\end{matrix} ) = ( \begin{matrix}{W}_{\_ status \_ 1 \_ c 3} & {W}_{\_ status \_ 1 \_ c 2} & {W}_{\_ status \_ 1 \_ c 1} & {W}_{\_ status \_ 1 \_ c 0} \\ {W}_{\_ status \_ 2 \_ c 3} & {W}_{\_ status \_ 2 \_ c 2} & {W}_{\_ status \_ 2 \_ c 1} & {W}_{\_ status \_ 2 \_ c 0}\end{matrix} ) \qquad ( Equation 9 )$$

Next, from each of the weights which are set in Step S410 to Step S450, a weight for the first travel path W total_1 and a weight for the second travel path W total_2 are computed, and are represented as the Equation 10 (Step S460).

### [Equation 10]

Eq. 10

W_{total_n_cx}=W_{bird_n_cx}×W_{sens_n_cx}×W_{dist_n_cx}×W_{map_n_cx}×W_{status_n_cx}(n=1,2,x=0,1,2,3) (Equation 10)

It is worth noticing that, as for the setting operation of each of the weights in Step S410 to step S450, setting results at one side do not influence the other setting operations. Therefore, there are no restrictions about an order of computation.

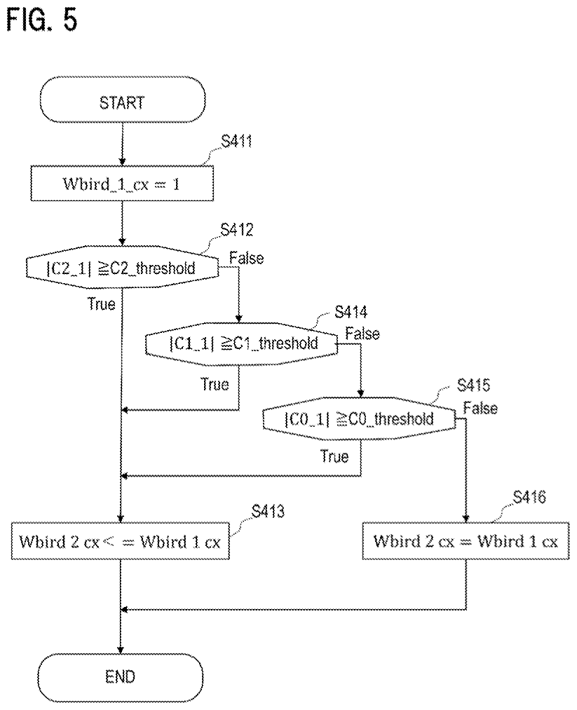

Next, using the flow chart of FIG. 5, explanation will be made about the operation of the bird's-eye view detection travel path weight setting part 91 which sets a bird's-eye view detection travel path weight W bird, from the information on the first travel path generation part 60 according to the Embodiment 1, where the bird's-eye view detection travel path weight is to the first travel path and the second travel path. It is worth noticing that, FIG. 5 is a flow chart which shows the details in the operation in Step S410 of FIG. 4, and computation for every step in the flow chart is performed, while the vehicle is moving.

First, the weight of the bird's-eye view detection travel path weight W bird_1_cX (X=0, 1, 2, 3) for the first travel path is set to be a maximum vale of 1 (Step S411). Next, it is judged whether the magnitude of the coefficient of a curvature element of an approximated curve is larger than a threshold value C2_threshold, namely, it is judged whether a road curvature is larger than the threshold value C2_threshold (Step S412), where the approximated curve shows the relation between a host vehicle and a target path, and is computed in the first travel path generation part 60. When it is judged that the path curvature is larger in Step S412, the bird's-eye view detection travel path weight W bird_2_cX to the second travel path is set as a value which is smaller than the bird's-eye view detection travel path weight W bird_1_cX to the first travel path (Step S413).

Moreover, when it is judged that the road curvature is smaller in Step S412, it is judged whether the magnitude of the coefficient of the angle element of an approximated curve is larger than a threshold value C1_threshold, namely, it is judged whether the inclination of a host vehicle to a travel path is larger than the threshold value C1_threshold (Step S414), where the approximated curve shows the relation between the host vehicle and the target path and is computed in the first travel path generation part 60. When it is judged in Step S414 that the inclination of a host vehicle to a travel path is larger, the process proceeds to Step S413. Moreover, when it is judged in Step S414 that the inclination of a host vehicle to a travel path is smaller, it is judged whether the magnitude of the coefficient of the position element of an approximated curve is larger than the threshold value Cθ_threshold, namely, it is judged whether the distance of the host vehicle to a travel path is separated more than the threshold value Cθ_threshold, where the approximated curve shows the relation between a host vehicle and a target path and is computed in the first travel path generation part 60 (Step S415).

When it is judged that the host vehicle is separated with respect to a travel path in Step S415, the process proceeds to Step S413. Moreover, when it is judged that the host vehicle is not separated with respect to a travel path in Step S415, it is judged that the accuracy of the second travel path is high. Further, the bird's-eye view detection travel path weight W bird_2_cX for the second travel path is set as a value which is equivalent to the bird's-eye view detection travel path weight W bird_1_cX for the first travel path (Step S416).

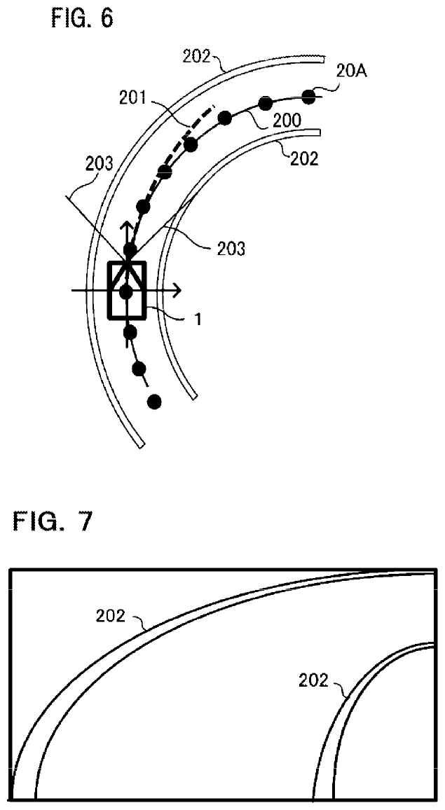

In the operation of the bird's-eye view detection travel path weight setting part 91 according to the Embodiment 1, FIG. 6 is a drawing showing the output result of the first travel path generation part 60 and the second travel path generation part 70, when the magnitude of the coefficient of the path curvature of a travel path is larger than the set threshold value C2_threshold (the state of True in Step S412).

In FIG. 6, the first travel path 200 is a travel path which is computed in the first travel path generation part 60. The first travel path 200 is a travel path which represents the relation of a target path to the host vehicle 1, using an approximated curve, on the basis of the absolute coordinate information and absolute azimuth on the host vehicle 1, from the host vehicle position and azimuth detection part 10, and the information on the target point sequence 20A of a host vehicle drive lane, from the road map data 20. The first travel path 200 is a travel path which is acquired from results detected in a bird's-eye view from the host vehicle 1 and the information on the target point sequence, and then, it can be said that the first travel path is a high precision path.

The second travel path 201 is a travel path which is computed in the second travel path generation part 70. Moreover, the numeral 202 in FIG. 6 represents a road division line. Moreover, the numeral 203 is an image capturing range boundary of the front camera sensor 30. The graphical image information within the range of this image capturing range boundary 203 is acquired. The second travel path 201 is the one which represents the relation between a host vehicle 1 and the front path of the host vehicle 1, using an approximated curve, on the basis of the information with the front camera sensor 30, on the road division line 202 which is ahead of the host vehicle 1 and.

In the vehicle state of FIG. 6, FIG. 7 is a drawing showing a state in which the image of the road division line 202 ahead of the host vehicle 1 is captured with the front camera sensor 30.

As shown in FIG. 7, the image of a road division line 202 is captured with the front camera sensor 30. When a path of the road division line is the one with a large curvature, the detection information of a division line at one side becomes extremely narrow. Then, it becomes difficult to represent accurately the travel path which is computed from the shape of the division line 202, using an approximated curve. As a result, as for the road division line 202, the travel path information in which an error is included with respect to an actual travel path will be output. Therefore, in such a situation, the weight of the second travel path 201, which is shown in FIG. 6, is set to be a relatively low value to the weight for the first travel path 200.

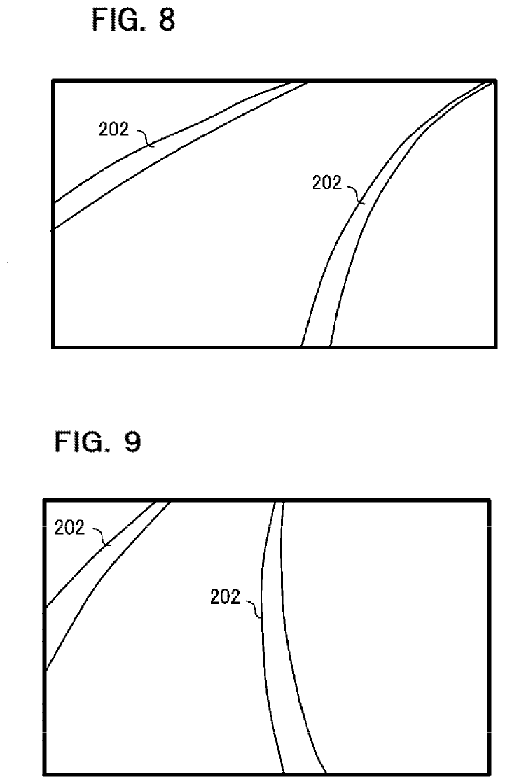

FIG. 8 is a drawing showing another example, in the operation of the bird's-eye view detection travel path weight setting part 91 according to the present Embodiment 1. Further, FIG. 8 is a drawing showing an image capturing state by the front camera sensor 30, regarding the road division line 202 which is ahead of the host vehicle, where the magnitude of the coefficient of the path curve of a travel path is smaller than the set threshold value C2_threshold, and in addition, when the magnitude of the coefficient of the angle between a host vehicle and a travel path is larger than the set threshold value C1_threshold (the state of True in Step S414).

As shown in FIG. 8, the image of a road division line 202 is captured with the front camera sensor 30. When the angle deviation of a travel path to the host vehicle 1 is large, the detection information on a road division line 202 at one side becomes extremely narrow. Thereby, it becomes difficult to represent accurately the travel path which is computed from the shape of the road division line 202, using an approximated curve. As a result, as for the road division line 202, the travel path information in which an error is included to an actual travel path is output. Therefore, in such a situation, the weight of the second travel path 201 is set to be a relatively low value to the weight for the first travel path 200.

FIG. 9 is a drawing which shows still another example, in the operation of the bird's-eye view detection travel path weight setting part 91 according to the present Embodiment 1. That is, FIG. 9 is a drawing showing the state by the front camera sensor 30, in which the image of a road division line 202, ahead of the host vehicle 1, is captured, when the magnitude of the coefficient of the path curve of a travel path is smaller than the set threshold value C2_threshold, and in addition when the magnitude of the coefficient of the angle of a travel path is smaller than the set threshold value C1_threshold to a host vehicle, and in addition when the magnitude of the coefficient of the position between a host vehicle and a travel path is larger than the set threshold value Cθ_threshold (the state of True in Step S415).

As shown in FIG. 9, the image of a road division line 202 is captured with the front camera sensor 30. When the position deviation of a travel path to the host vehicle 1 is large, the detection information on the division line at one side becomes extremely narrow. Further, it becomes difficult to represent accurately the travel path which is computed from the shape of the road division line 202 to the host vehicle 1, using an approximated curve. As a result, the travel path information in which an error is included to an actual travel path is output. Therefore, in such a situation, the weight for the second travel path 201 is set to be a relatively low value to the weight for the first travel path 200.

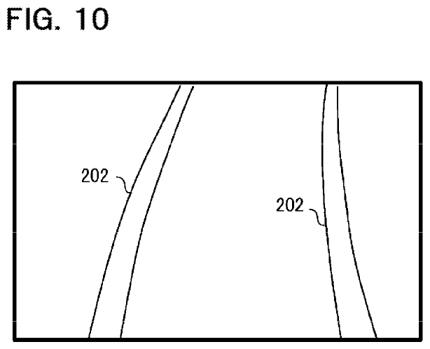

FIG. 10 is a drawing which shows still another example, in the operation of the bird's-eye view detection travel path weight setting part 91 according to the present Embodiment 1. That is, FIG. 10 is a drawing showing a state by the front camera sensor 30 where the image of a road division line 202, which is ahead of the host vehicle 1, is captured, when the magnitude of the coefficient of the path curve of a travel path is smaller than the threshold value C2_threshold, and in addition when the magnitude of the coefficient of the angle between a host vehicle and a travel path is smaller than the threshold value C1_threshold, and in addition, when in the case where the magnitude of the coefficient of the position between a host vehicle and a travel path is smaller than the threshold value Cθ_threshold (the state of False in Step S415).

In the scene where a path curvature is small as in FIG. 10, the angle deviation of a travel path is small to the host vehicle 1, and the position error of a travel path is also small to the host vehicle 1, the road division line 202 whose image is captured with the front camera sensor 30 is arranged in the central part of the image capturing range. Therefore, it becomes possible to represent the travel path which is computed from the host vehicle 1 and the shape of a division line with sufficient accuracy, using an approximated curve. For this reason, in such a situation, the weight of the second travel path 201 is set to be a high value which is equivalent to the weight of the first travel path 200.

In this way, according to the travel path generation device 1000 of vehicle use in the Embodiment 1, a weight is output to the weight integration part 96, from each of the bird's-eye view detection travel path weight setting part 91, the vehicle state weight setting part 92, the path distance weight setting part 93, the peripheral environment weight setting part 94, and the detection means state weight setting part 95, and further, the weight between the first travel path 200 and the second travel path 201 is set on the basis of each of the weights. Thereby, for example, even in the situation where the second travel path generation part 70 outputs the travel path information which is different from an actual travel path, it becomes possible in the bird's-eye view detection travel path weight setting part 91 to set a low weight to the concerned travel path depending on the positional relationship of a travel path to the host vehicle 1, from the information of the first travel path 200. Therefore, it becomes possible to generate an integrated travel path which is further in agreement with the actual travel path, and the convenience of an automatic operation function can be enhanced.

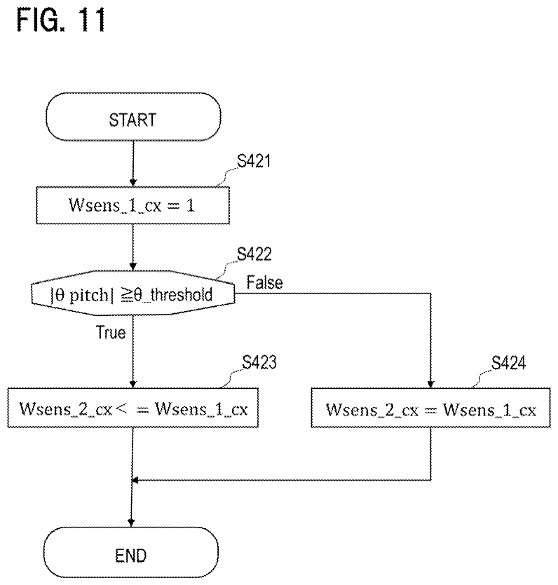

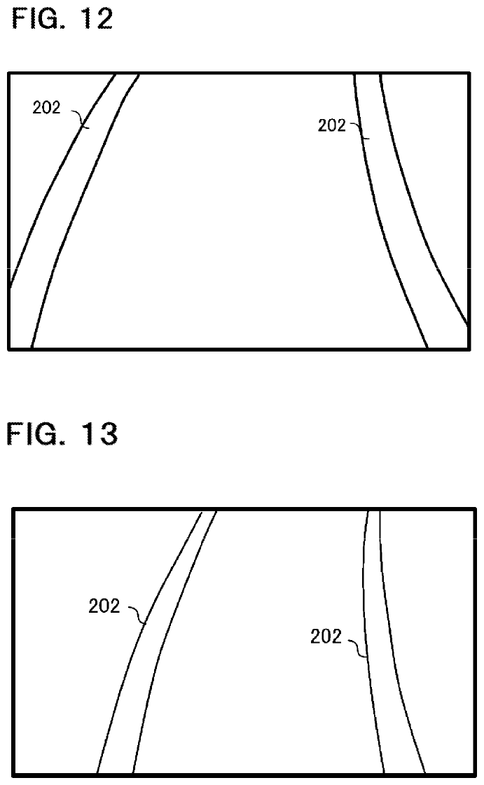

Next, using the flow chart of FIG. 11 according to the Embodiment 1, explanation will be made about the operation of the vehicle state weight setting part 92 which sets a vehicle state weight W sens on the basis of the information from the vehicle sensor 40. It is worth noticing that FIG. 11 is a flow chart which shows the details of the operation in Step S420 of FIG. 4, and computation for every step in the flow chart is performed, while the vehicle is moving.

First, the weight of the vehicle state weight W sens_1_cX (X=0, 1, 2, 3) for the first travel path 200 is set to be a maximum value of 1 (Step S421). Next, it is judged whether the vehicle body pitch angle 9 pitch of the host vehicle 1 is larger than a threshold value θ_threshold, from the information of the vehicle sensor 40 which is mounted in the host vehicle 1, namely, it is judged whether the vehicle body is tilted frontward or backward (Step S422). When it is judged in Step S422 that the vehicle body pitch angle is larger, a vehicle state weight W sens_2_cX to the second travel path 201 is set to be a value which is smaller than the vehicle state weight W sens_1_cX to the first travel path 200 (Step S423). Moreover, when it is judged in Step S423 that the vehicle body pitch angle is smaller, it is judged that the accuracy of the second travel path 201 is high, and then, the vehicle state weight W sens_2_cX for the second travel path 201 is set to be a value which is equivalent to the vehicle state weight W sens_1_cX for the first travel path 200 (Step S424).

In the operation of the vehicle state weight setting part 92 according to the present Embodiment 1, FIG. 12 shows an image capturing state (the state of True in Step S422), by the front camera 30, of the road division line 202 which is ahead of the host vehicle 1, when the magnitude of a vehicle body pitch angle is larger than the set threshold value θ pitch_threshold (when the vehicle body is tilted to the frontward side). Moreover, FIG. 13 shows an image capturing state (the state of False in Step S422), by the front camera 30, of the road division line 202 which is ahead of the host vehicle 1, when the magnitude of a vehicle body pitch angle is smaller than the set threshold value θ pitch_threshold.

In FIG. 13, the image of a road division line 202 is captured with the front camera sensor 30. As compared with the state of FIG. 12, the length of a distance (a lane width) between the road division lines 202 at both sides is image captured long, and the distance of the image captured road division line 202 is short as compared with the state of FIG. 12. As a result, the travel path information in which an error is included to an actual travel path is output. Therefore, in the state where a vehicle body pitch angle is large, the weight for the second travel path 201 is set to be a relatively low value to the weight for the first travel path 200.

In the state where a vehicle body pitch angle is small as in FIG. 12, it becomes possible to represent the travel path computed from the shape of the road division line 202 to the host vehicle 1, with sufficient accuracy, using an approximated curve. For this reason, in such a situation, the weight of the second travel path 201 is set to be a high value which is equivalent to the weight of the first travel path 200.

Moreover, as mentioned already, the first travel path information which is output from the first travel path generation part 60 is a travel path which represents, in a bird's-eye view, the relation of a target path to the host vehicle 1, using an approximated curve, where the absolute coordinate information and absolute azimuth of the host vehicle 1, from the host vehicle position and azimuth detection part 10, and the information on the target point sequence 20A of a host vehicle drive lane, from the road map data 20 are used. Then, the decrease in the accuracy of a path due to the influence of a vehicle body pitch angle is small. From above, it can be said that the first travel path 200 is a high precision path to an actual travel path.

In this way, the travel path generation device 1000 of vehicle use according to the Embodiment 1 makes it possible to set a low weight to the concerned travel path, in the situation where, in a vehicle state weight setting part, the travel path information of the second travel path generation part is different from an actual travel path due to the influence of the vehicle body pitch angle of a host vehicle. Thereby, it becomes possible to generate an integrated travel path which is further in agreement with the actual travel path, and the convenience of an automatic operation function can be enhanced.

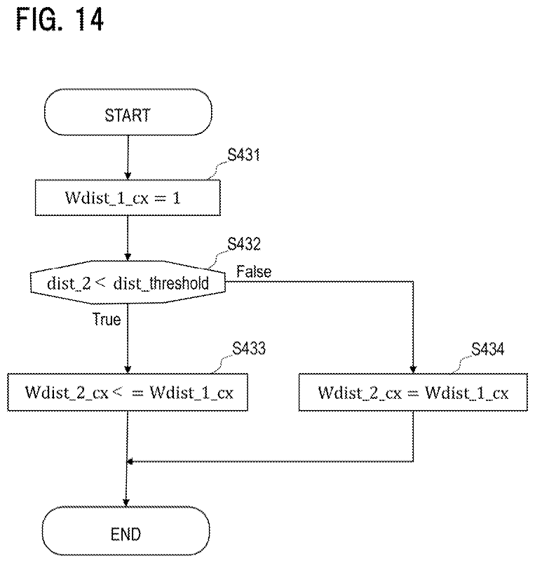

Next, using the flow chart of FIG. 14 according to the Embodiment 1, explanation will be made about the operation of the path distance weight setting part 93 which sets a path distance weight W dist, where the operation is by the information on the path distance of the second travel path generation part 70. It is worth noticing that, FIG. 14 is a flow chart which shows the details of the operation in Step S430 of FIG. 4, and computation for every step in the flow chart is performed, while the vehicle is moving.

First, the weight of a path distance weight W dist_1_cX (X=0, 1, 2, 3) for the first travel path is set to be a maximum value of 1 (Step S431). Next, it is judged whether the path detection distance dist_2 in the second travel path generation part is shorter than a set threshold value dist_threshold (Step S432). When it is judged in Step S432 that the detection distance of the second travel path is shorter, the weight of the path distance weight W dist_2_cX for the second travel path is set to be a value which is smaller than the path distance weight W dist_1_cX for the first travel path (Step S433). Moreover, when it is judged in Step S432 that the detection distance of the second travel path 201 is longer, the weight of the path distance weight W distt_2_cX for the second travel path 201 is set to be a value which is equivalent to the path distance weight W dist_1_cX for the first travel path 200 (Step S434).

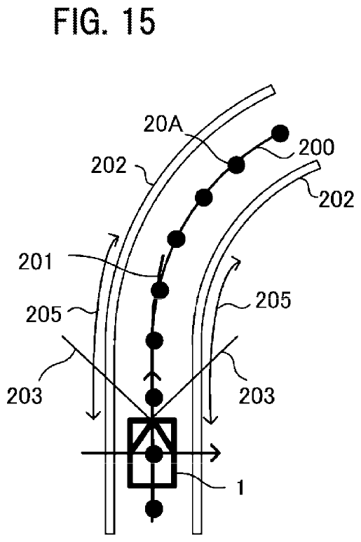

In order to represent the operation of the path distance weight setting part 93 according to the present Embodiment 1, FIG. 15 is a drawing which shows the state of the second travel path 201 which is computed by the second travel path generation part 70. In FIG. 15, the host vehicle 1 is on the way to enter a curve way through a clothoid part from a straight way.

The first travel path 200 is a travel path denoted by an approximated curve, showing the relation of the target path to the host vehicle 1, on the basis of the absolute coordinate information and absolute azimuth of the host vehicle 1, from the host vehicle position and azimuth detection part 10 A, and the information on the target point sequence 20A of a host vehicle drive lane, from the road map data 20. In addition, the first travel path is a travel path which is acquired from the result detected in a bird's-eye view, and then, it can be said that the first travel path is a path whose reliability is high. The second travel path 201 is a path which is generated using the information within the range of the image capturing distance 205, among the road division lines 202 whose images are captured with the front camera sensor 30.

As shown in FIG. 15, when the image capturing distance 205 is short, it is difficult for the second travel path 201 to reproduce the travel path of a curve way, from the clothoid which is ahead of the host vehicle 1. Further, a travel path in which an error is included to an actual travel path will be output. Therefore, the weight for the second travel path 201 is set to be a relatively low value to the weight for the first travel path 200.

In the Equation 11, shown is an equation for computing a threshold value dist_threshold in Step S432 of FIG. 14. For example, when the speed of a vehicle is low, an accuracy in the path near a host vehicle is required in automatic operation. As shown in the Equation 11, the dist_threshold is computed from the speed V of a host vehicle and a constant Tld. Comparing with a detection distance, the weight for the second travel path 201, which is generated near the host vehicle only, can be set to be a value which is equivalent to the weight for the first travel path 200. Accordingly, it becomes possible to generate an optimal travel path.

### [Equation 11]

Eq. 11

dist_threshold=V×T_{ld} (Equation 11)

In this way, the detection distance of the second travel path generation part is short in a path distance weight setting part. Thereby, the travel path generation device of vehicle use according to the Embodiment 1 makes it possible to set a low weight to the concerned travel path, in the situation where the travel path information of the second travel path generation part is different from an actual travel path. Therefore, it becomes possible to generate an integrated travel path which is further in agreement with an actual travel path, and the convenience of an automatic operation function can be enhanced.

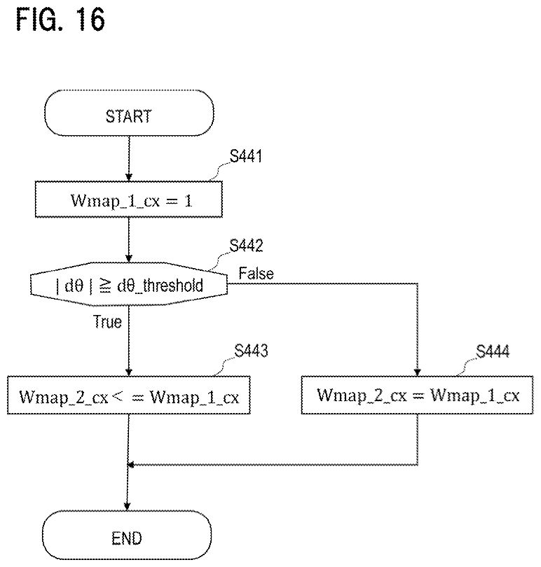

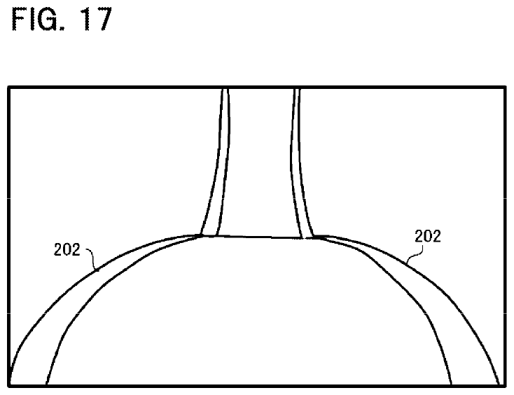

Next, using the flow chart of FIG. 16 according to the Embodiment 1, explanation will be made about the operation of the peripheral environment weight setting part 94 which sets a weight W_map, by the information from the road map data 20. It is worth noticing that, FIG. 16 is a flow chart which shows the details of the operation in Step S440 of FIG. 4, and computation for every step in the flow chart is performed, while the vehicle is moving.

First, the weight of the peripheral environment weight W map1_cX (X=0, 1, 2, 3) for the first travel path 200 is set to be a maximum value of 1 (Step S441). Next, it is judged, using the information from the map data 20, whether the magnitude of a changed amount d θ of a road slope, between the current position of a host vehicle and a fixed distance point ahead of the host vehicle, is larger than the set threshold value d θ slope_threshold (Step S442). When it is judged in Step S442 that the change of a road slope is larger, the peripheral environment weight W map_2_cX for the second travel path 201 is set to be a value which is smaller than the peripheral environment weight W map_1_cX for the first travel path 200 (Step S443). Moreover, when it is judged in Step S442 that the change of a road slope is smaller, it is judged that the accuracy of the second travel path is high. Thereby, the peripheral environment weight W map_2_cX for the second travel path 201 is set to be a value which is equivalent to the peripheral environment weight W map_1_cX for the first travel path 200 (Step S424).

In the operation of the peripheral environment weight setting part 94 according to the present Embodiment 1, the road slope, which is in the range between the host vehicle 1 and the front, changes from a downward slope to an upward slope. FIG. 17 is a drawing showing an image capturing state of a road division line and a leading vehicle whose images are captured with the front camera sensor 30, when it is judged that the magnitude of the change amount of a road slope is larger than the set threshold value d θ slope_shreshold (the state of True in Step S442).

In FIG. 17, the image of a road division line 202 is captured with the front camera sensor 30. Due to the influence of change in the road slope, the information on the shape of the road division line 202 which includes both the right line and the left line is different from an actual road shape. As a result, the output of the second travel path generation part 70 will be the travel path information in which an error is included with respect to an actual travel path. Therefore, when the change amount of the road slope, which is in the range between the host vehicle 1 and the front, is large, the peripheral environment weight W map_2_cX for the second travel path 201 is set to be a relatively low value to the peripheral environment weight W map_1_cX for the first travel path 200.

In this way, in the travel path generation device 1000 of vehicle use according to the Embodiment 1, the change amount of a front road slope is large to the host vehicle 1, in the peripheral environment weight setting part 94. Thereby, in the situation where the travel path information of the second travel path generation part 70 is different from an actual travel path, it becomes possible to set a low weight to the second travel path 201. Therefore, it becomes possible to generate an integrated travel path which is further in agreement with the actual travel path, and the convenience of an automatic operation function can be enhanced.

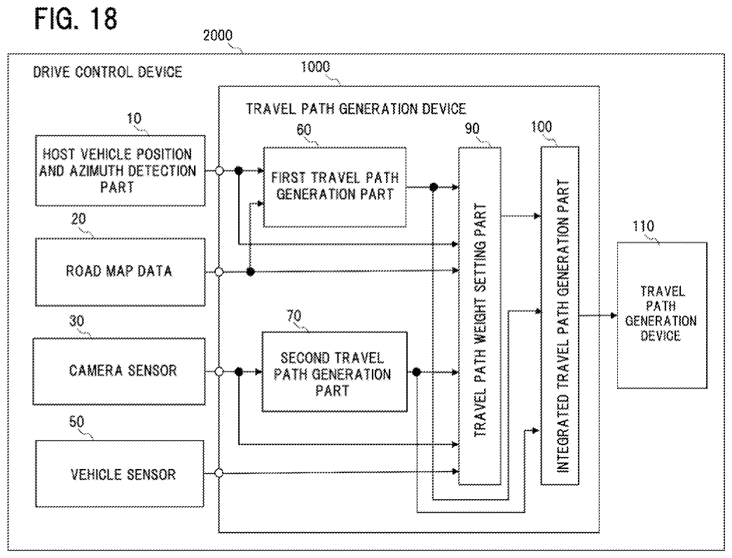

It is worth noticing that, in the Embodiment 1, as shown in FIG. 18, a case is assumed in which the drive control device 2000 is configured by providing the information, on an integrated travel path from the travel path generation device 1000, to the vehicle control part 110. However, it is allowed to employ the travel path generation device as a vehicle path generation device independently.

Next, regarding the method for generating a first travel path, explanation will be made about another example of the path generation by a “bird's-eye view” detection means. It is worth noticing that, according to the present Embodiment, in the first travel path generation part 60, the first travel path information is output from the host vehicle position and azimuth detection part 10 and the road map data 20. However, the method is not necessarily a means which uses the positioning information from an artificial satellite and road map data.

For example, load sensors, such as a millimeter wave sensor, a laser sensor (Lidar), or a camera sensor, which are installed on a telegraph pole or signboard at a travel path end, are used to recognize the position and angle of a vehicle in a sensing domain and the peripheral road shape of the vehicle. Further, a polynomial equation is used to express the relation between a host vehicle and a travel path on the periphery of the host vehicle. Thereby, the same benefit can be acquired.

It is worth noticing that, according to the present Embodiment, as shown in the Equation 3, the Equation 5, the Equation 6, the Equation 7, the Equation 8, the Equation 9, and the Equation 10, a weight which is set to the first travel path and a weight which is set to the second travel path are set in the travel path weight setting part 90. Those weights are set to a coefficient of each order, when the weight is denoted by an approximate equation of third order. However, those weights are not necessarily a weight to a coefficient of each order.

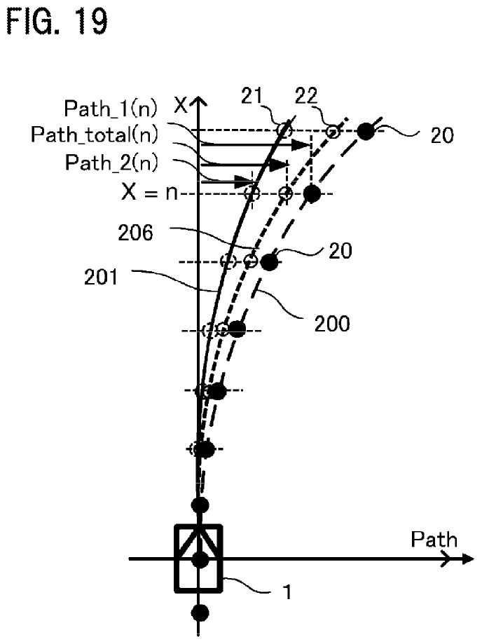

For example, the first travel path and the second travel path are changed into point group information, which is expressed in the target pass point of each path. It is allowed to employ the point group information also as a weight to each path. FIG. 19 shows the relation of respective paths at the time when the first travel path and the second travel path are used as the point group information.

The weight W which is set by the path weight setting part 90 is shown in the Equation 12, the bird's-eye view detection travel path weight W bird is shown in the Equation 13, the vehicle state weight W sens is shown in the Equation 14, the path distance weight W dis is shown in the Equation 15, the peripheral environment weight W map is shown in the Equation 16, the detection means state weight W status is shown in the Equation 17, and the weight for the first travel path Wtotal_1, and the weight for the second travel path Wtotal_2 are both shown in the Equation 18.

$$[ Equation 12 ]$$

$$Eq . 12$$

$$W = ( \begin{matrix}{W}_{total \_ 1} \\ {W}_{total \_ 2}\end{matrix} ) \qquad ( Equation 12 )$$

$$[ Equation 13 ]$$

$$Eq . 13$$

$${W}_{\_ bird} = ( \begin{matrix}{W}_{\_ bird \_ 1} \\ {W}_{\_ bird \_ 2}\end{matrix} ) \qquad ( Equation 13 )$$

$$[ Equation 14 ]$$

$$Eq . 14$$

$${W}_{\_ sens} = ( \begin{matrix}{W}_{\_ sens \_ 1} \\ {W}_{\_ sens \_ 2}\end{matrix} ) \qquad ( Equation 14 )$$

$$[ Equation 15 ]$$

$$Eq . 15$$

$${W}_{\_ dist} = ( \begin{matrix}{W}_{\_ dist \_ 1} \\ {W}_{\_ dist \_ 2}\end{matrix} ) \qquad ( Equation 15 )$$

$$[ Equation 16 ]$$

$$Eq . 16$$

$${W}_{\_ map} = ( \begin{matrix}{W}_{\_ map \_ 1} \\ {W}_{\_ map \_ 2}\end{matrix} ) \qquad ( Equation 16 )$$

$$[ Equation 17 ]$$

$$Eq . 17$$

$${W}_{\_ status} = ( \begin{matrix}{W}_{\_ status \_ 1} \\ {W}_{\_ status \_ 2}\end{matrix} ) \qquad ( Equation 17 )$$

$$[ Equation 18 ]$$

$$Eq . 18$$

$${W}_{total \_ n} = {W}_{bird \_ n} \times {W}_{sens \_ n} \times {W}_{dist \_ n} \times {W}_{map \_ n} \times {W}_{status \_ n} \\ ( n = 1 , 2 ) \qquad ( Equation 18 )$$

It is worth noticing that, as shown in FIG. 19, the point group 21 of the second travel path 201 is generated by assigning a front-back direction coordinate value of the point group 20 of the first travel path 200, to the Equation 2. After that, the weight to each path, which is computed by the Equation 18, is assigned to the Equation 4, and weighting is carried out to the distance of the horizontal direction, with respect to the distance of a host vehicle front-back direction in each path. Thereby, the point group 22 is generated, and employed as an integrated travel path 206, and then, the same benefit can be acquired.

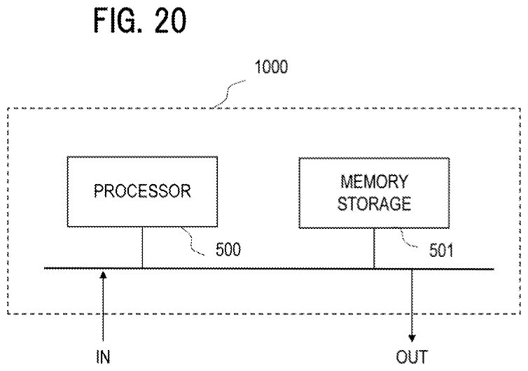

It is worth noticing that, as shown in FIG. 20 which represents an example of hardware, the travel path generation device 1000 consists of a processor 500 and a memory storage 501. Although the contents of the memory storage are not illustrated, the memory storage is equipped with volatile storages, such as a random access memory, and the nonvolatile auxiliary storage unit, such as a flash memory. Moreover, it is allowed to provide an auxiliary storage unit of hard disk type, instead of a flash memory. The processor 500 executes the program which is input from the memory storage 501. In this case, a program is input into the processor 500 through a volatile storage from an auxiliary storage unit. Moreover, the processor 500 may output the data of an operation result and the like to the volatile storage of the memory storage 501, and may save data through a volatile storage in an auxiliary storage unit.

Although the present application is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present application. For example, at least one of the constituent components may be modified, added, or eliminated.

### EXPLANATION OF NUMERALS AND SYMBOLS

1 Host vehicle: 10 Host vehicle position and azimuth detection part: 20 Road map data: 20A Target point sequence: 30 Front camera sensor: 40 Vehicle sensor: 60 First travel path generation part: 70 Second travel path generation part: 90 Travel path weight setting part: 91 Bird's-eye view detection travel path weight setting part: 92 Vehicle state weight setting part: 93 Path distance weight setting part: 94 Peripheral environment weight setting part: 95 Detection means state weight setting part: 96 Weight integration part: 100 Integrated travel path generation part: 200 First travel path: 201 Second travel path: 202 Road division Line: 203 Image capturing range boundary: 205 Image capturing distance: 206 Integrated travel path: 500 Processor: 501 Memory storage: 1000 Travel path generation device: 2000 Drive control device

1. A vehicle travel path generation device, comprising
a first travel path generator which approximates a lane on which a host vehicle travels to output as first travel path information,
a second travel path generator which approximates a road division line ahead of the host vehicle to output as second travel path information,
a travel path weight setter which sets a weight denoting a certainty between the first travel path information and the second travel path information, and
an integrated travel path generator which generates an integrated travel path information, using the first travel path information, the second travel path information, and the weight by the travel path weight setter,
wherein the travel path weight setter sets the weight, on the basis of at least one of outputs from a bird's-eye view detection travel path weight setter, a vehicle state weight setter, a path distance weight setter, and a peripheral environment weight setter,
where the bird's-eye view detection travel path weight setter computes a weight between the first travel path information and the second travel path information, on the basis of the first travel path information,
the vehicle state weight setter computes a weight between the first travel path information and the second travel path information, on the basis of a state of the host vehicle,
the path distance weight computes a weight between the first travel path information and the second travel path information, on the basis of a distance of a travel path of the second travel path information, and
the peripheral environment weight setter computes a weight between the first travel path information and the second travel path information, on the basis of a peripheral road environment of the host vehicle.

2. The vehicle travel path generation device according to claim 1,
wherein, among the first travel path information, the weight is set on the basis of a magnitude of a curvature component of the travel path, a magnitude of an angular component between the travel path and the host vehicle, and a magnitude of a lateral position component between the travel path and the host vehicle, and
when the magnitude of the curvature component is larger than a first threshold value, the bird's-eye view detection travel path weight setter sets the weight for the second travel path information to be smaller than the weight for the first travel path information,
when the magnitude of the curvature component is smaller than the first threshold value, and in addition, the magnitude of the angular component is larger than a second threshold value, the bird's-eye view detection travel path weight setter sets the weight for the second travel path information to be smaller than the weight for the first travel path information, and
when the magnitude of the curvature component is smaller than the first threshold value, and in addition, the magnitude of the angular component is smaller than the second threshold value, and in addition the magnitude of the lateral position component is larger than a third threshold value, the bird's-eye view detection travel path weight setter sets the weight for the second travel path information to be smaller than the weight for the first travel path information.

3. The vehicle travel path generation device according to claim 1,
wherein, when a magnitude of a vehicle pitch angle obtained with a vehicle sensor is larger than a fourth threshold value, the vehicle state weight setter sets the weight for the second travel path information to be smaller than the weight for the first travel path information.

4. The vehicle travel path generation device according to claim 1,
wherein, when a second travel path distance of the second travel path information is shorter than a fifth threshold value, the path distance weight setter sets the weight for the second travel path information to be smaller than the weight for the first travel path information.

5. The vehicle travel path generation device according to claim 1,
wherein, when a change of a path slope ahead of the host vehicle is larger than a sixth threshold value, the peripheral environment weight setter sets the weight for the second travel path information to be smaller than the weight for the first travel path information.

6. The vehicle travel path generation device according to claim 1,
wherein the travel path weight setter computes the weight between the first travel path information and the second travel path information, according to the following Equation.
[Equation 19]
Eq. 19
W_{total_n_cx}=W_{bird_n_cx}×W_{sens_n_cx}×W_{dist_n_cx}×W_{map_n_cx}×W_{status_n_cx}(n=1,2,x=0,1,2,3) (Equation 19)

7. The vehicle travel path generation device according to claim 1,
wherein the first travel path information and the second travel path information are constituted by a curvature component of a travel path, an angular component between the host vehicle and the travel path, and a lateral position component between the host vehicle and the travel path,
the weight of the first travel path information and the weight of the second travel path information, which are output from the travel path weight setter, are the ones set as weights to each of the curvature component, the angular component, and the lateral position component, which are by the first travel path information and the second travel path information.

8. The vehicle travel path generation device according to claim 1, further comprising a vehicle controller which controls the host vehicle, on the basis of the first travel path information and the second travel path information.

9. A method for generating a vehicle travel path, comprising
a first step for recognizing a travel path on which a host vehicle travels in a bird's-eye view, and outputting first travel path information,
a second step for including information on a periphery travel path of the host vehicle,
a third step for detecting a shape of the travel path on which the host vehicle travels,
a fourth step for detecting a traveling state of the host vehicle,
a fifth step for computing a weight from an output of the fourth step,
a sixth step for receiving the information of the third step, and outputting a second travel path information, and
a seventh step for generating an integrated travel path information, on the basis of an output information of a travel path weight setter, the first travel path information, and the second travel path information, where the travel path weight setter sets a weight denoting a certainty between the first travel path information and the second travel path information
wherein, in the seventh step, the weight is set on the basis of at least one of outputs of an eighth step, a ninth step, a tenth step, and an eleventh step,
where in the eighth step, a weight between the first travel path information and the second travel path information is computed on the basis of the first travel path information,
in the ninth step, a weight between the first travel path information and the second travel path information is computed on the basis of a state of the host vehicle,
in the tenth step, a weight between the first travel path information and the second travel path information is computed on the basis of a distance of a travel path of the second travel path information, and
in the eleventh step, a weight between the first travel path information and the second travel path information is computed on the basis of a peripheral road environment of the host vehicle.

10. The method for generating a vehicle travel path according to claim 9,
wherein, among the first travel path information, the weight is set on the basis of a magnitude of a curvature component of the travel path, a magnitude of an angular component between the travel path and the host vehicle, and a magnitude of a lateral position component between the travel path and the host vehicle,
when the magnitude of the curvature component is larger than a first threshold value, the weight for the second travel path information is set to be smaller than the weight for the first travel path information in the eighth step,
when the magnitude of the curvature component is smaller than the first threshold value, and in addition, the magnitude of the angular component is larger than a second threshold value, the weight for the second travel path information is set to be smaller than the weight for the first travel path information in the eighth step, and
when the magnitude of the curvature component is smaller than the first threshold value, and in addition, the magnitude of the angular component is smaller than a second threshold value, and in addition, the magnitude of the lateral position component is larger than a third threshold value, the weight for the second travel path information is set to be smaller than the weight for the first travel path information in the eighth step.

11. The method for generating a vehicle travel path according to claim 9,
wherein, when a magnitude of a vehicle pitch angle obtained with a vehicle sensor is larger than a fourth threshold value, the weight for the second travel path information is set to be smaller than the weight for the first travel path information in the ninth step.

12. The method for generating a vehicle travel path according to claim 9,
wherein, when a second travel path distance, namely, a distance of a travel path of the second travel path information is shorter than a fifth threshold value, the weight for the second travel path information is set to be smaller than the weight for the first travel path information in the tenth step.

13. The method for generating a vehicle travel path according to claim 9,
wherein, when the change of the path slope ahead of the host vehicle is larger than a sixth threshold value, the weight for the second travel path information is set to be smaller than the weight for the first travel path information in the eleventh step.

14. The method for generating a vehicle travel path according to claim 9,
wherein the weight between the first travel path information and the second travel path information is computed according to the following Equation in the seventh step.
[Equation 20]
Eq. 20
W_{total_n_cx}=W_{bird_n_cx}×W_{sens_n_cx}×W_{dist_n_cx}×W_{map_n_cx}×W_{status_n_cx}(n=1,2,x=0,1,2,3) (Equation 20)

15. The method for generating a vehicle travel path according to claim 9,
wherein the first travel path information and the second travel path information are constituted by a curvature component of a travel path, an angular component between the host vehicle and the travel path, and a lateral position component between the host vehicle and the travel path, and
the weight for the first travel path information and the weight for the second travel path information, which are output from the seventh step, are set as weights of the curvature component, the angular component, and the lateral position component, for the first travel path information and the second travel path information.

16. The method for generating a vehicle travel path according to claim 9,
comprising a twelfth step for controlling the host vehicle, on the basis of a target path which is generated by the method for generating a vehicle travel path therein.
